(19) United States
(12) Patent Application Publication
(10) Pub. No.: US 2006/0075108 A1
(43) Pub. Date: Apr. 6, 2006

(54) Network media gateway

(75) Inventor: Dany Sylvain, Gatineau (CA)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 10/941,201

(22) Filed: Sep. 15, 2004

(51) Int. Cl. G06F 15/16

(52) U.S. Cl. 709/227

(57) ABSTRACT

The present invention provides a network media gateway (NMG) that provides a centralized interface between different types of consumer electronics devices and service providers through one or more disparate networks. The network media gateway may enable a single consumer electronics device to interact with different service providers over different types of networks in order to receive one or more services. The network media gateway may also allow multiple consumer electronics devices, which typically interact with different service providers, to interact with multiple service providers over disparate types of networks. The network media gateway may also allow the consumer electronics devices to interact with one another.

### FIELD OF THE INVENTION

The present invention relates to communications, and in particular to providing a network media gateway to facilitate interworking among disparate types of consumer devices and service networks.

### BACKGROUND OF THE INVENTION

Traditionally, telephone and television services have been provided by different service providers over different networks to different consumer devices. The Public Switched Telephone Network (PSTN) provides telephone services to telephones, whereas cable providers provide television services through a cable network to a consumer's set-top box or television. With the rapid growth and acceptance of the Internet and associated packet-based communications, many multimedia services, including voice communications and delivery of video, are being provided over packet networks in addition to traditional data transfer. Further, both cable and telephone service providers are capable of providing broadband internet access. As such, there are numerous types of networks and service providers through which television, telephony, and data services may be provided.

Even though there are a growing number of options for receiving television, telephone, and data services, each service is substantially isolated from one another, even if multiple services are provided by a common service provider. For example, both cable and telephone service providers offer broadband services through dedicated modems, such as cable modems or digital subscriber line modems, in addition to the traditional television or telephone services. However, there is limited ability to provide data and television or telephone services to a single device to provide a high quality multimedia experience based on a combination of disparate services. For example, there is no easy way to support packet-based services and television services on a single television, let alone have the television interact with the PSTN to receive caller identification information, call alerts, or otherwise participate in a call. Thus, there is a need for an efficient and effective way to allow consumer devices to cooperatively interact with multiple services or service providers to provide a more rewarding user experience. There is a further need to allow multiple consumer devices, which have different primary functions, to cooperate with one another to further enhance functionality and ease of use. There is a particular need to combine broadcast and broadband services to offer a more unified media experience among different types of consumer devices.

### SUMMARY OF THE INVENTION

The present invention provides a network media gateway (NMG) that provides a centralized interface between different types of consumer electronics devices and service providers through one or more disparate networks. The network media gateway may enable a single consumer electronics device to interact with different service providers over different types of networks in order to receive one or more services. The network media gateway may also allow multiple consumer electronics devices, which typically interact with different service providers, to interact with multiple service providers over disparate types of networks. The network media gateway may also allow the consumer electronics devices to interact with one another.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a traditional communication environment according to the prior art;

FIG. 2 illustrates a communication environment according to a first embodiment of the present invention;

FIG. 3 illustrates a communication environment according to a second embodiment of the present invention;

FIG. 4 illustrates a first aspect of the present invention;

FIG. 5 illustrates a second aspect of the present invention;

FIG. 6 illustrates a third aspect of the present invention;

FIG. 7 illustrates a fourth aspect of the present invention; and

FIG. 8 illustrates a block representation of a network media gateway according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

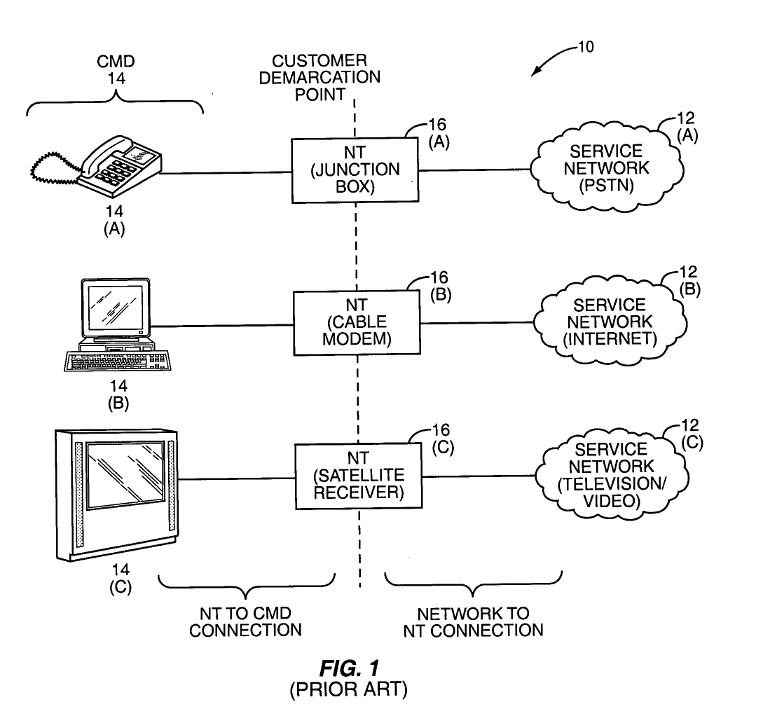

To better understand the benefits of the present invention, a brief overview of how multiple services are traditionally provided to a customer premises is illustrated. With reference to FIG. 1, a typical communication environment 10 is illustrated where different service providers use different service networks 12 (A, B, and C) to deliver different types of services to different types of consumer media devices (CMDs) 14 (A, B, and C). Notably, each service is provided separately from the other services. In the illustrated example, the service networks 12A, 12B, and 12C correspond to the PSTN for providing traditional telephone services (12A), the Internet through a cable service provider (12B), and a television/video service provider (12C), which may be the cable company, over the air broadcast, or satellite service providers. In general, separate network terminations (NTs) 16 (A, B, and C) are used to provide the interface between the service networks 12 (A, B, and C) and the consumer media devices 14 (A, B, and C). In the instant case, the network termination 16A for the PSTN is a traditional junction box, which may include protection circuitry. The network termination 16B for the Internet may be a cable modem, and the network termination 16C for satellite television services, such as those provided through direct broadcast satellite (DBS) systems, may be a satellite receiver. For the Internet and television services, the cable modem will connect wirelessly or directly to the CMD 14B, which may be a personal computer, and the satellite receiver may connect directly to the CMD 14C, which may be a television or like video monitor. Depending on the service, the network termination-to-CMD connection may be facilitated through wired or wireless means. Similarly, the network-to-network termination connection may be provided through wired or wireless means, wherein the wired techniques may include copper, fiber, or other acceptable delivery mechanisms.

From the above, it is clear that the isolation between the various services limits the ability for any one of the CMDs 14 (A, B, and C) to receive different types of services from one or more of the service networks 12 (A, B, and C). Even in cable systems, where broadband and television services are provided, a unique set-top box for television services is provided along with a unique cable modem for broadband services. These boxes do not facilitate interworking between those CMDs 14 requiring broadband services and those requiring television services. As such, the CMDs 14 cannot communicate over multiple networks or using different services, in addition to not being able to receive different services from one or more of the service networks 12 (A, B, and C). Further, different types of CMDs 14 are limited in their ability to interact with one another.

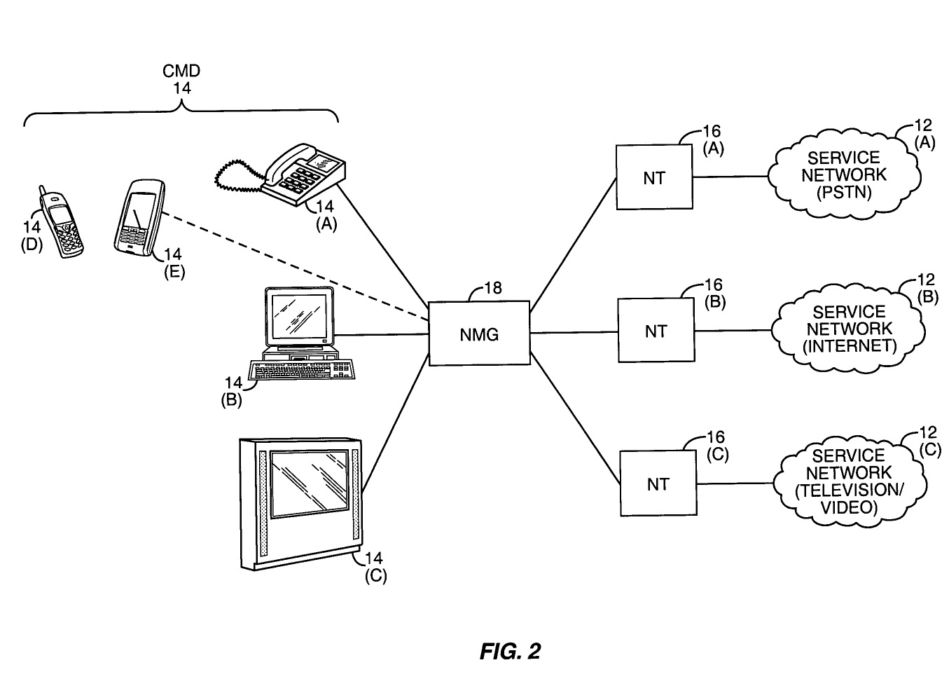

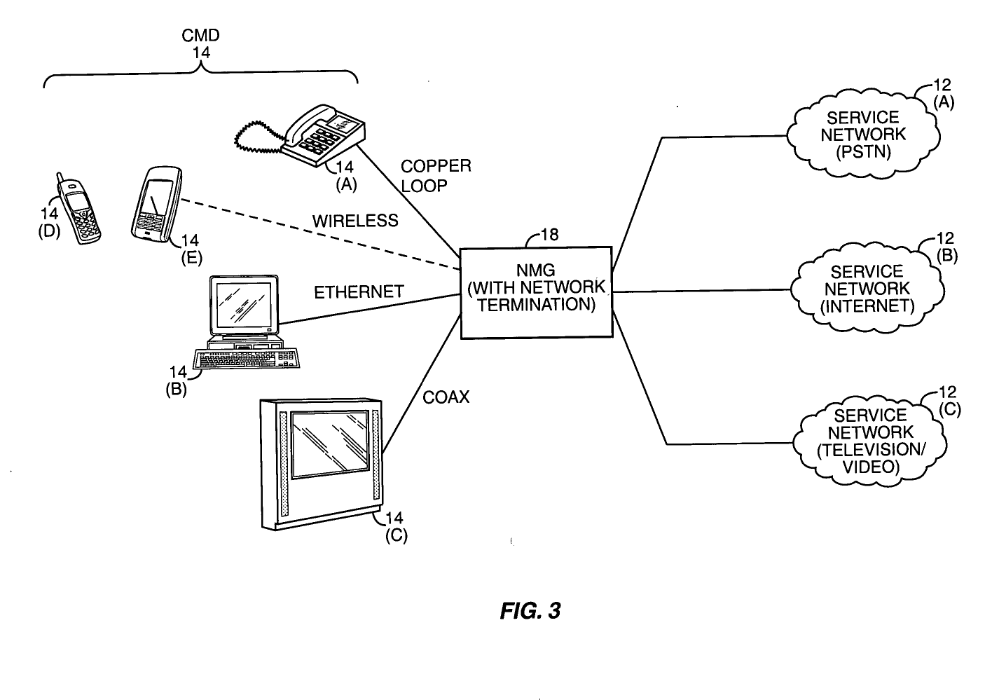

As illustrated in FIG. 2, the present invention provides a network media gateway (NMG) 18 as a centralized interface between the various CMDs 14 and the various service networks 12. The network media gateway 18 may interface with the service networks 12 (A, B, and C) through respective network terminations 16 (A, B, and C). Alternatively, as illustrated in FIG. 3, the network terminations 16 may be integrated within the network media gateway 18 in whole or in part. Further, the functionality of the network media gateway 18 may be integrated into one or more of the CMDs 14. As illustrated, the CMDs 14 may take any number of forms, including the telephone of CMD 14A, the personal computer of CMD 14B, the television of CMD 14C, a mobile terminal, such as a cellular telephone of CMD 14D, or a wireless capable personal digital assistant (PDA) as illustrated as CMD 14E.

The network media gateway 18 will generally include at least two different types of network inputs and be connected to or integrated in at least one type of CMD 14. The different network inputs may correspond to different services provided over a common network or different services provided by different service networks and service providers. The network inputs may correspond to analog or digital telephony, broadcast television, satellite television, cable television, broadband, radio, and local wireless communications. The listed interfaces are merely exemplary and are not intended to limit the scope of the invention. The telephony interface may include a standard telephone system interface, an integrated services digital network (ISDN), digital subscriber line (DSL), or dial-up internet connection. The television interfaces, regardless of whether they are broadcast, satellite, or cable, may support analog and digital television signals, including high definition television signals. The broadband interface may support broadband services through DSL, TI, cable, or satellite interfaces. The local wireless interface may be that for local wireless communications provided by the IEEE 802.11, .16, or .20 standards, Bluetooth standards, cellular, or other wireless standards. The CMDs 14 may take any number of forms from cordless telephones, remote controls, home theater equipment, stereo equipment, video recorders, video cameras, or any other device benefiting from being able to communicate with other CMDs 14 or one or more service networks 12.

For communications between traditionally incompatible CMDs 14 and service networks 12, the network media gateway 18 will provide the necessary protocol and media adaptations to either allow the CMD 14 to receive information from the service network 12, allow the CMD 14 to send information over the service network 12, or a combination thereof to facilitate any type of audio, video, data, or voice communications. The adaptations of the protocol or media require the necessary modifications or translations of signaling messages or media formats such that messages or information may be transmitted between the CMD 14 and the service network 12. The adaptation may take place in either direction, and may be provided for communications between the disparate service networks 12 as well as disparate CMDs 14. The network media gateway 18 will provide the gateway between these various CMDs 14 and service networks 12 to implement a common interface that allows interworking between the respective CMDs 14 and the service networks 12.

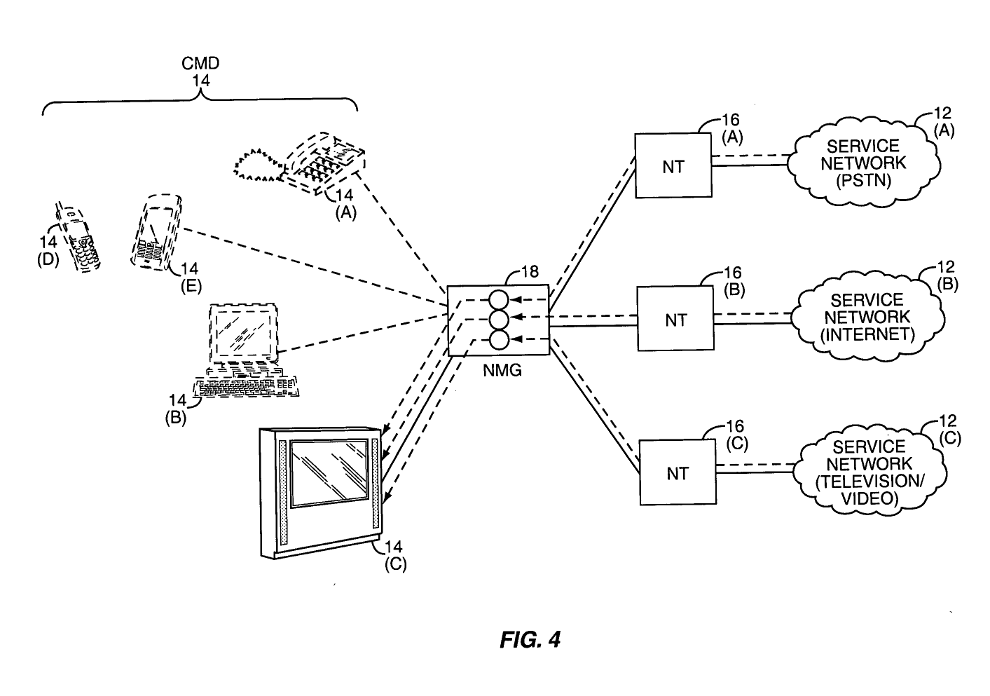

As illustrated in FIG. 4, one embodiment of the invention allows a single CMD 14, television 14C as depicted, to communicate with more than one network, and thus receiving multiple services in an effort to provide additional flexibility to the given CMD 14. Notably, the network media gateway 18 may provide one or more wired or wireless connections to the television 14C. As an example corresponding to the service networks 12 (A, B, and C) being the PSTN, Internet, and satellite, respectively, the television 14C may receive television signals from the service network 12C, static or streaming audio or video content from the Internet 12B, and may receive telephone calls from the PSTN 12A. For the television and Internet content, both may be accessible and selectable directly from the television's user input, television remote control, or a separate remote control, which is capable of controlling the network media gateway 18 directly. Further, other of the CMDs 14, such as the PDA 14E, may be used as a controller of the television 14C, the network media gateway 18, or a combination thereof.

Telephone calls or information associated therewith may be received by the television 14C and processed accordingly. In one embodiment, caller identification information associated with the PSTN or voice over packet (VoP) calls via the Internet may be sent to the television 14C and displayed or announced on or through the television 14C. Further, the audio associated with a video call may be played through the speakers associated with the television 14C. If the television 14C is equipped with a microphone or camera, bidirectional audio or video calls may be established. The audio and video may be supported by the same or different ones of the service networks 12. For example, the audio may be established through the PSTN wherein the corresponding video session is established over the Internet. Notably, the television and Internet services may be provided over a common network, such as a cable network. In this case, the network media gateway 18 will allow the traditionally disparate services to be used in a coordinated fashion by a single CMD 14.

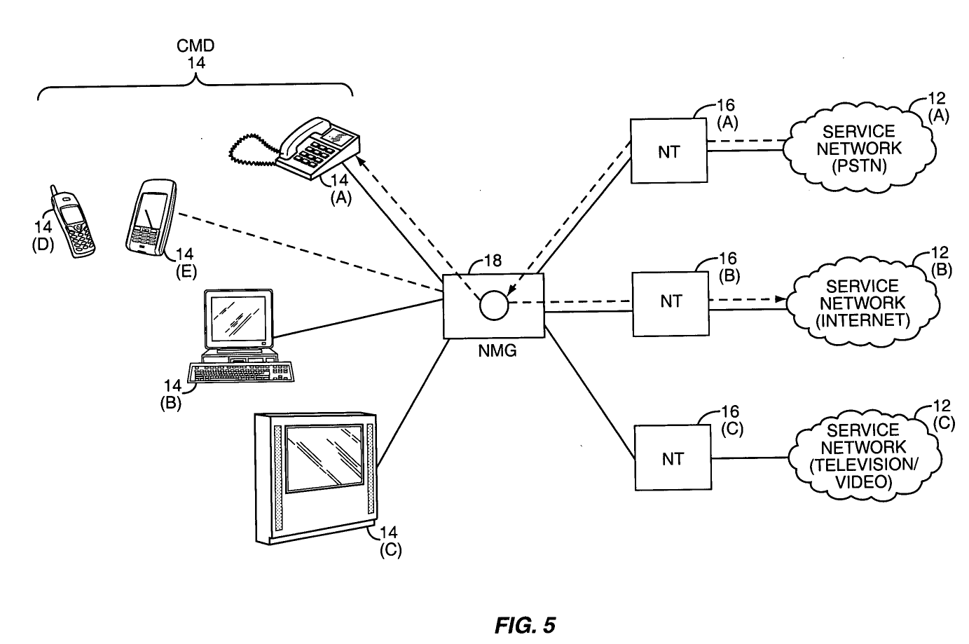

In another embodiment, as illustrated in FIG. 5, the network media gateway 18 can support service interactions across service networks 12. Traditionally, such interactions would have been very difficult to achieve. These interactions generally entail supplementing a service supported by one of the service networks 12 with additional services supported by a different service network 12. For example, for an incoming call through the PSTN, the call may be directed to telephone 14A and the caller identification information associated with the call may be used to access a database on the Internet to obtain additional information, such as a picture of the caller or associated information for the caller or the call. The associated information may be received by the network media gateway 18 and provided to the user via another of the CMDs 14, such as the personal computer 14B, the television 14C, or PDA 14E. In another example, the network media gateway 18 may be used to initiate a call to a customer service or support call center upon receiving a message via the Internet that an agent is available for receiving a call at the call center, thereby avoiding long holding times.

For a video call, the network media gateway 18 may initiate a video session over the Internet upon cooperating with the telephone 14A to establish a voice session through a call over the PSTN. Yet another example would be after establishing a call over the PSTN, using the dialed number to access a website on the Internet with the dialed number to obtain the address for a website associated with the dialed number. The network media gateway 18 may use the address for the website associated with the dialed number and provide any received content to the personal computer 14B, television 14C, PDA 14E, or a combination thereof.

The network media gateway 18 may also recognize an incoming call over the PSTN, obtain the caller identification information or content associated with the caller based on the caller identification from the Internet, and display the caller identification or associated information on a television 14C while television services are being received via the service network 12C. Either automatically or upon user direction, the network media gateway 18 may take the necessary steps to begin recording or otherwise buffering the audio and video content from the television service on an internal or external video recorder to allow the call to proceed. Once the call ends, the television content may resume where the recording or buffering began. Those skilled in the art will recognize additional ways in which the network media gateway 18 can interface with one or more networks or services to provide a multi-service interface to one or more of the CMDs 14.

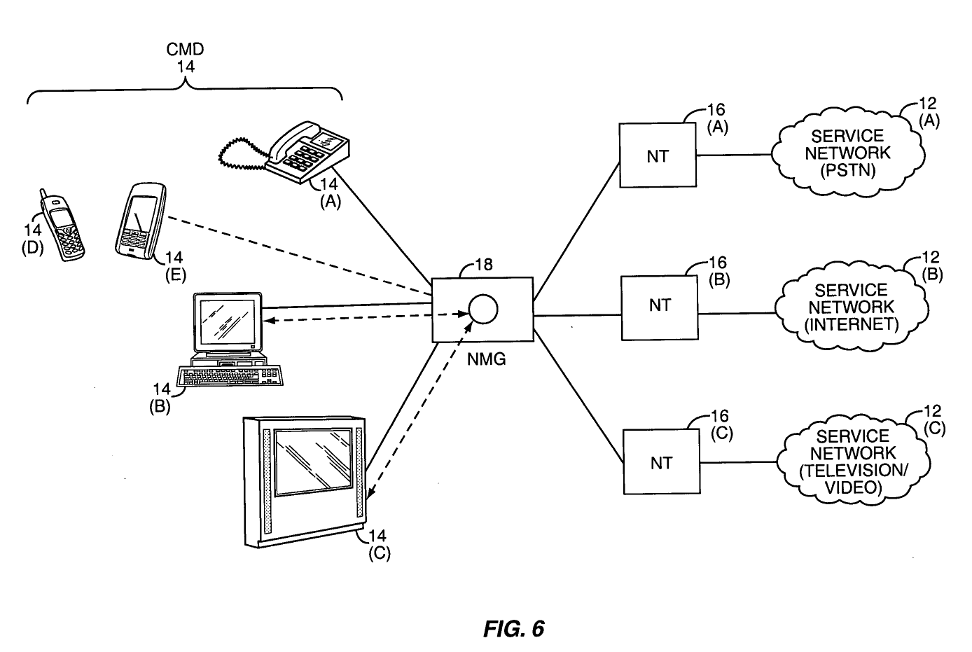

Since the network media gateway 18 interfaces with more than one service network 12, the network media gateway 18 is able to communicate with different types of devices that would normally interface with only one network. As illustrated in FIG. 6, the network media gateway 18 can facilitate communications and functionality between CMDs 14 that had been previously impossible or impractical. For example, the network media gateway 18 may operate to send recorded video, pictures, audio, or other media content from any of the CMDs 14 capable of storing such content, such as the PDA 14E, personal computer 14B, VCR, DVD, or mobile terminal 14D to a television 14C, personal computer 14B, PDA 14E, telephone 14A, mobile terminal 14D, or other home theater or monitoring device. Again, the network media gateway 18 will take any necessary steps to provide the necessary adaptation such that the information may be displayed. For example, information displayed on a television 14C may need to be converted from an original format to an NTSC, digital video interface, RGB, or other format for display on the television 14C. In another example, web content may be accessed and displayed on any of the CMDs 14, including the television 14C, based on Uniform Resource Locators (URLs) or other address information received via a video feed provided to the television 14C. As such, supplementary information on the subject matter of the programming, actors, players, teams, and other aspects of the video content may be accessed and provided to the user on one or more of the CMDs 14. Additional information for products or services may be accessed upon viewing commercials or product placements in the video.

In another embodiment, streaming video or a television program may be distributed to multiple CMDs 14. Further, the volume for television channels, web content, or other collectible audio, video, or like content, may be selected from another one of the CMDs 14 as if it were a remote control. The telephone 14A, which may be acting as a cordless telephone with the network media gateway 18 as a base station, may also be used as the remote control. If presence information bearing on the relative availability for ways in which communications can be established with others is available over the Internet or from another source, presence information may be accessed and displayed on the personal computer 14B, television 14C, or other CMD 14 while watching a television program, receiving a telephone call, or participating in another media session.

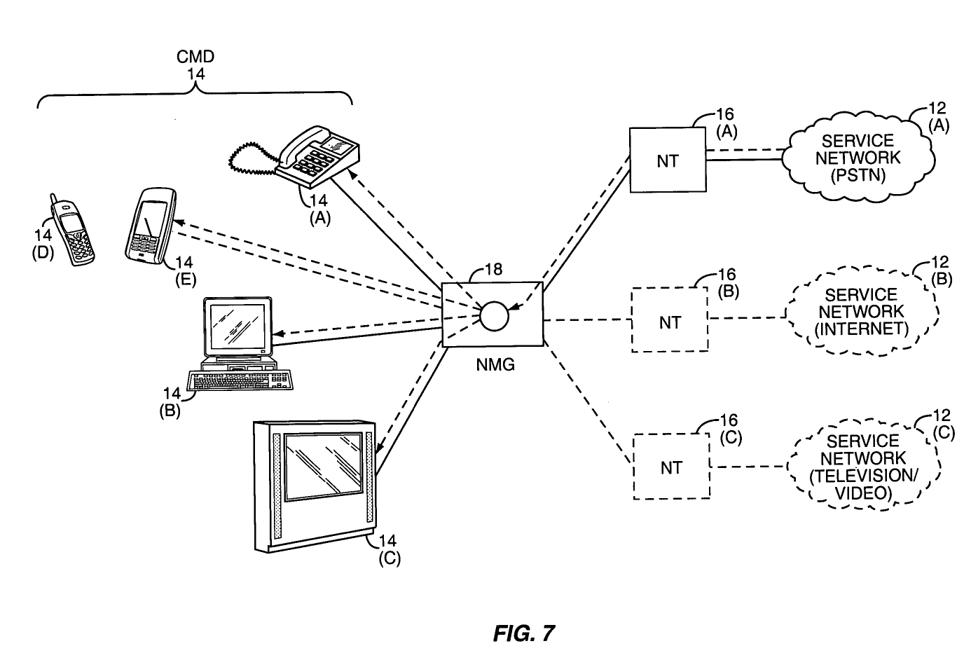

As alluded to above and specifically illustrated in FIG. 7, the network media gateway 18 is able to distribute content received from one service network 12 to multiple CMDs 14 and provide the necessary adaptation to allow information to be received or displayed appropriately. For example, although the telephony devices are normally connected directly to the PSTN, the network media gateway 18 allows other ones of the CMDs 14 to provide telephony-related functions. These functions may include providing incoming call alerts, displaying caller ID information, controlling call waiting, and directing call forwarding. Non-telephony CMDs 14 may be used to play voicemail, display call logs, as well as make and receive calls. Again, the network media gateway 18 will provide the necessary adaptation for such interworking.

For a video service provider, which is normally connected to a television and video recorder, the network media gateway 18 may allow other CMDs 14, such as the personal computer 14B, PDA 14E, or other web appliance, to provide video-related functions. These functions may include viewing analog, digital, or high definition television content on any capable device with the appropriate adaptation for resolution, screen size, color screening, refresh rate, and the like. Further, video recording or snapshots of certain video content may be received by or taken from any of the capable CMDs 14. Further, the computing devices, such as the personal computer 14B and the PDA 14E, are normally connected through the Internet or other computing devices.

With the network media gateway 18 acting as a liaison between the CMDs 14 and multiple service networks 12, various types of multimedia sessions involving data, voice, audio, and video may be established with any number of CMDs 14. Voice over Packet sessions may be established with the telephone 14A, personal computer 14B, television 14C, or PDA 14E. Video provided by one of the CMDs 14 or one of the service networks 12, such as the Internet or the television service, may be provided to the personal computer 14B or PDA 14E, in addition to being provided to the television 14C or associated video recorder. Web browsing may be facilitated on the television 14C in addition to that traditionally provided by the personal computer 14B or PDA 14E. These unique services or other multimedia services may be facilitated in any combination with the CMDs 14 via the network media gateway 18.

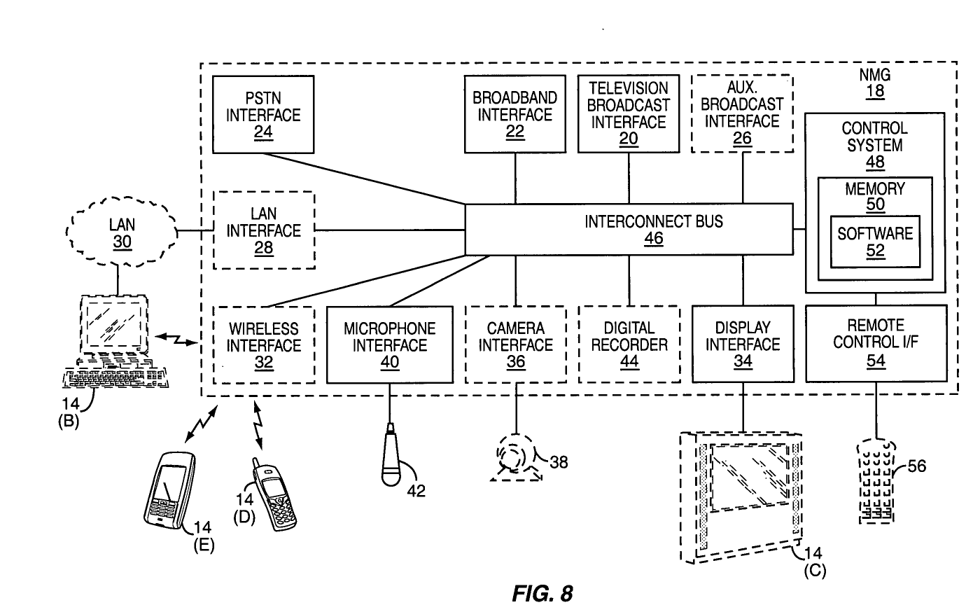

Turning now to FIG. 8, an exemplary network media gateway 18 is illustrated. The network media gateway 18 will include numerous interfaces for interfacing with the various service networks 12, as well as the CMDs 14, through wired or wireless interfaces. In the illustrated example, the network media gateway 18 may include a television broadcast interface 20 for receiving television signals via satellite over the air channels or via a cable service. The television broadcast interface 20 will include or be associated with the requisite receiver circuitry for receiving, and decoding as necessary, television signals from the various sources. The network media gateway 18 may also include a broadband interface 22 for interfacing with a broadband service network, such as that provided via cable, DSL, or other broadband service.

A PSTN interface 24 may be included for connecting to a traditional PSTN telephony line. The PSTN interface 24 may include the requisite circuitry for converting between the analog signal provided on the telephony line to a digital format supported by the network media gateway 18. Any of these interfaces may be replicated as desired. For example, an auxiliary broadcast interface 26 may be provided such that television services from a different provider may be received through the television broadcast interface 20 and the auxiliary broadcast interface 26. Satellite services may be received via a satellite antenna connected to the television broadcast interface 20 wherein over the air channels may be received via an aerial antenna connected to the auxiliary broadcast interface 26.

The network media gateway 18 may include a local area network (LAN) interface 28, which may be connected to a LAN 30. The LAN 30 may support various computing devices, such as the personal computer 14B. A wireless interface 32 may also be provided by the network media gateway 18, and as such, the wireless interface 32 may support wireless communications with the personal computer 14B, PDA 14E, and the mobile terminal 14D. The wireless interface 32 may also facilitate communications to a telephone handset to facilitate traditional cordless operation wherein the network media gateway 18 acts as a base station for the cordless telephone system. Further, various remote controls or devices acting as remote controls may interface with the network media gateway 18 through the wireless interface 32. The wireless interface 32 may support traditional cordless telephone technologies, both analog and digital, as well as Bluetooth, IEEE 802.11, and other wireless local area network (WLAN) standards.

A display interface 34 having the appropriate display drivers and adaptation circuitry for video may also be provided in the network media gateway 18 to provide the appropriate signals to various video devices or monitors, such as the television 14C. The display interface 34, as well as the other interfaces, may be configured for wired or wireless operation. The display interface 34 may support any type of video, including NTSC, component, DVI, or the like. A camera interface 36 may be provided with an associated camera 38 for taking still images or video. The network media gateway 18 may also include a microphone interface 40 and an associated microphone 42. Notably, audio or video may be received from other ones of the CMDs 14.

The network media gateway 18 may also include any number of CMD-type functions, such as a digital recorder 44, which may be used to record audio, video, voice, or other data. Thus, the digital recorder 44 may function as a digital video recorder for television programming or streamed video content from the Internet, as well as act as an answering machine or other recording device. All of these functions are effectively interconnected with an interconnect bus 46, which is also operably connected to a control system 48, which will effectively control all of the operational aspects of the network media gateway 18 and support the interaction and adaptation of the interfaces and their corresponding signals and media, respectively. The control system 48 will include a memory 50 for storing the requisite software 52 to provide the functionality described above. The control system 48 may be associated with a remote control interface 54 for interacting with a dedicated remote control 56, which may operate using traditional infrared technology, as well as other local wireless communication techniques.

Those skilled in the art will recognize improvements and modifications to the preferred embodiments of the present invention. All such improvements and modifications are considered within the scope of the concepts disclosed herein and the claims that follow.

What is claimed is:

1. A network media gateway comprising:
a consumer device interface adapted to couple to a consumer device;
at least one network interface adapted to couple to at least one network; and
a control system associated with the consumer device interface and the at least one network interface and adapted to facilitate a plurality of services from the at least one network interface to the consumer device.

2. The network media gateway of claim 1 wherein a first of the plurality of services is a broadband service and a second of the plurality of services is a broadcast service.

3. The network media gateway of claim 1 wherein the at least one network interface comprises a plurality of network interfaces, each of the plurality of network interfaces coupled to one of a plurality of networks providing one of the plurality of services.

4. The network media gateway of claim 3 wherein a first of the plurality of network interfaces is a broadband interface and a second of the plurality of network interfaces is a broadcast interface and a first of the plurality of services is a broadband service and a second of the plurality of services is a broadcast service.

5. The network media gateway of claim 3 wherein the control system is further adapted to facilitate a media session between two of the plurality of networks via two of the plurality of network interfaces.

6. The network media gateway of claim 3 wherein the control system is further adapted to facilitate an interaction between two of the plurality of networks via two of the plurality of network interfaces.

7. The network media gateway of claim 1 further comprising a second consumer device interface adapted to couple to a second consumer device.

8. The network media gateway of claim 7 wherein the control system is further adapted to facilitate a plurality of the services from the at least one network interface to the second consumer device.

9. The network media gateway of claim 7 wherein the control system is further adapted to receive a first control signal from the second consumer device and send a second control signal to the consumer device, the second control signal adapted to cause the consumer device to take an action corresponding to the first control signal.

10. The network media gateway of claim 9 wherein the consumer device is a different type of device than the second consumer device.

11. The network media gateway of claim 7 wherein the control system is further adapted to facilitate a media session between the consumer device and the second consumer device via the consumer device interface and the second consumer device interface.

12. The network media gateway of claim 7 wherein the control system is further adapted to facilitate an interaction between the consumer device and the second consumer device via the consumer device interface and the second consumer device interface.

13. The network media gateway of claim 1 further comprising a public switched telephone network interface and a second consumer device interface associated with the control system, the control system is further adapted to facilitate a telephony service to the second consumer device via the public switched telephone network interface and the second consumer device interface.

14. The network media gateway of claim 1 wherein one of the services is a broadcast service.

15. The network media gateway of claim 14 wherein the broadcast service is a television service.

16. The network media gateway of claim 1 wherein one of the services is a broadband service

17. The network media gateway of claim 16 wherein the broadband service is provided by one of a group consisting of digital subscriber loop, integrated digital subscriber network, satellite service, and cable network.

18. The network media gateway of claim 1 further comprising a memory associated with the control system, which is further adapted to store content provided from one of the plurality of services.

19. The network media gateway of claim 18 wherein the content is television content.

20. The network media gateway of claim 1 further comprising a second consumer device interface and wherein the at least one network interface comprises a broadband interface for broadband service, a broadcast interface for television broadcast service, and a public switched telephone network interface, and adapted to facilitate a telephony service to a second consumer device via the public switched telephone network interface and the second consumer device interface.

21. A method comprising:
providing a consumer device interface adapted to couple to a consumer device;
providing at least one network interface adapted to couple to at least one network; and
facilitating a plurality of services from the at least one network interface to the consumer device.

22. The method of claim 21 wherein a first of the plurality of services is a broadband service and a second of the plurality of services is a broadcast service.

23. The method of claim 21 further comprising providing a plurality of network interfaces, each of the plurality of network interfaces coupled to one of a plurality of networks providing one of the plurality of services.

24. The method of claim 23 wherein a first of the plurality of network interfaces is a broadband interface and a second of the plurality of network interfaces is a broadcast interface and a first of the plurality of services is a broadband service and a second of the plurality of services is a broadcast service.

25. The method of claim 23 further comprising facilitating a media session between two of the plurality of networks via two of the plurality of network interfaces.

26. The method of claim 23 further comprising facilitating an interaction between two of the plurality of networks via two of the plurality of network interfaces.

27. The method of claim 21 further comprising providing a second consumer device interface adapted to couple to a second consumer device.

28. The method of claim 27 further comprising facilitating a plurality of the services from the at least one network interface to the second consumer device.

29. The method of claim 27 further comprising receiving a first control signal from the second consumer device and sending a second control signal to the consumer device, the second control signal adapted to cause the consumer device to take an action corresponding to the first control signal.

30. The method of claim 29 wherein the consumer device is a different type of device than the second consumer device.

31. The method of claim 27 further comprising facilitating a media session between the consumer device and the second consumer device via the consumer device interface and the second consumer device interface.

32. The method of claim 27 further comprising facilitating an interaction between the consumer device and the second consumer device via the consumer device interface and the second consumer device interface.

33. The method of claim 21 further comprising providing a public switched telephone network interface and a second consumer device interface and facilitating a telephony service to the second consumer device via the public switched telephone network interface and the second consumer device interface.

34. The method of claim 21 wherein one of the services is a broadcast service.

35. The method of claim 34 wherein the broadcast service is a television service.

36. The method of claim 21 wherein one of the services is a broadband service

37. The method of claim 36 wherein the broadband service is provided by one of a group consisting of digital subscriber loop, integrated digital subscriber network, satellite service, and cable network.

38. The method of claim 21 further comprising storing content provided from one of the plurality of services.

39. The method of claim 38 wherein the content is television content.

40. The method of claim 21 further comprising providing a second consumer device interface and wherein the at least one network interface comprises a broadband interface for broadband service, a broadcast interface for television broadcast service, and a public switched telephone network interface, and adapted to facilitate a telephony service to a second consumer device via the public switched telephone network interface and the second consumer device interface.
